(19) United States
(12) Patent Application Publication
(10) Pub. No.: US 2022/0027680 A1
(43) Pub. Date: Jan. 27, 2022

(54) METHODS AND SYSTEMS FOR FACILITATING CLASSIFICATION OF LABELLED DATA

(71) Applicant: BRAINOME INC., Alameda, CA (US)

(72) Inventors: Gerald Friedland, Alameda, CA (US); Bertrand Irissou, Sunnyvale, CA (US); Rishi Puri, Fremont, CA (US)

(21) Appl. No.: 17/178,059

(22) Filed: Feb. 17, 2021

Related U.S. Application Data
(60) Provisional application No. 63/056,862, filed on Jul. 27, 2020.

(51) Int. Cl. G06K 9/62; G06N 20/00

(52) U.S. Cl. CPC G06K 9/6268; G06N 20/00; G06K 9/6262; G06K 9/6256

(57) ABSTRACT

Disclosed herein is a method for facilitating classification of labelled data. Accordingly, the method may include receiving, using a communication device, a tabulated value file from a device, analyzing, using a processing device, the tabulated value file, determining, using the processing device, a complexity of the labelled data of the tabulated value file with respect to machine learning methods used for generating a machine learning model for classifying the labelled data based on the analyzing, identifying, using the processing device, a machine learning method of the machine learning methods based on the determining, configuring, using the processing device, a topology of a machine learning model associated with the machine learning method based on the identifying, training, using the processing device, a parameter of the machine learning model based on the configuring, generating, using the processing device, an executable classifier, and storing, using a storage device, the executable classifier.

The current application claims a priority to the U.S. Provisional Patent application Ser. No. 63/056,862 filed on Jul. 27, 2020.

### FIELD OF THE INVENTION

Generally, the present disclosure relates to the field of data processing. More specifically, the present disclosure relates to methods and systems for facilitating classification of labelled data.

### BACKGROUND OF THE INVENTION

Existing techniques for facilitating the classification of labelled data are deficient with regard to several aspects. For instance, current technologies do not provide automatic classification of the labelled data. Furthermore, current technologies do not facilitate the optimizing of the accuracy of a machine learner used for modeling a classifier that is used for performing the classification of the labelled data.

Therefore, there is a need for improved methods and systems for facilitating the classification of labelled data that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating classification of labelled data, in accordance with some embodiments. Accordingly, the method may include receiving, using a communication device, at least one tabulated value file from at least one device. Further, the method may include analyzing, using a processing device, the at least one tabulated value file. Further, the method may include determining, using the processing device, a complexity of the labelled data of the at least one tabulated value file with respect to a plurality of machine learning methods used for generating a machine learning model for classifying the labelled data based on the analyzing. Further, the method may include identifying, using the processing device, a machine learning method of the plurality of machine learning methods based on the determining. Further, the method may include configuring, using the processing device, a topology of a machine learning model associated with the machine learning method based on the identifying. Further, the method may include training, using the processing device, at least one parameter of the machine learning model based on the configuring. Further, the method may include generating, using the processing device, an executable classifier based on the training. Further, the executable classifier may be configured for classifying the labelled data of the at least one tabulated file based on executing of the executable classifier. Further, the method may include storing, using a storage device, the executable classifier.

Further disclosed herein is a system for facilitating classification of labelled data, in accordance with some embodiments. Accordingly, the system may include a communication device configured for receiving at least one tabulated value file from at least one device. Further, the system may include a processing device communicatively coupled with the communication device. Further, the processing device may be configured for analyzing the at least one tabulated value file. Further, the processing device may be configured for determining a complexity of the labelled data of the at least one tabulated value file with respect to a plurality of machine learning methods used for generating a machine learning model for classifying the labelled data based on the analyzing. Further, the processing device may be configured for identifying a machine learning method of the plurality of machine learning methods based on the determining. Further, the processing device may be configured for configuring a topology of a machine learning model associated with the machine learning method based on the identifying. Further, the processing device may be configured for training at least one parameter of the machine learning model based on the configuring. Further, the processing device may be configured for generating an executable classifier based on the training. Further, the executable classifier may be configured for classifying the labelled data of the at least one tabulated file based on executing of the executable classifier. Further, the system may include a storage device communicatively coupled with the processing device. Further, the storage device may be configured for storing the executable classifier.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating classification of labelled data, in accordance with some embodiments.

FIG. 3 is a flowchart of a method for facilitating classification of labelled data, in accordance with some embodiments.

FIG. 4 is a flowchart of a method for converting the at least one tabulated value file from a common format to an intermediate format for facilitating the classification of the labelled data, in accordance with some embodiments.

FIG. 5 is a flowchart of a method for determining at least one measurement for facilitating the classification of the labelled data, in accordance with some embodiments.

FIG. 6 is a flowchart of a method for generating a warning for facilitating the classification of the labelled data, in accordance with some embodiments.

FIG. 7 illustrates a plurality of methods associated with the disclosed apparatus, in accordance with some embodiments.

FIG. 8 is a flow chart of a method for facilitating building a classifier, in accordance with some embodiments.

FIG. 9 is a flow diagram of an automatic cleaning method for facilitating the building of the classifier, in accordance with some embodiments.

FIG. 10 is a flow diagram of a method for error check for facilitating the building of the classifier, in accordance with some embodiments.

FIG. 11 is a flow diagram of a method for building executable classifiers, in accordance with some embodiments.

FIG. 12 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating classification of labelled data, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, and apparatuses for facilitating classification of labelled data. Further, the disclosed apparatus may be configured for automatically compiling an executable classifier from labelled data. Further, the disclosed apparatus may enable fully automatic and deterministic creation of an executable classifier directly from the labelled data. Further, the disclosed apparatus may be configured for automatically compiling the executable classifier from a labelled set of data. Further, the disclosed apparatus may be structured similar to a traditional code compiler which takes in user-generated source code to generate machine executables. The disclosed apparatus takes comma-separated value files as input, automatically cleans them for further processing, measures the complexity of the data with respect to different machine learning methods, selects the machine learning method with the lowest risk of overfitting, architects the topology of that machine learning model, trains the parameters of the machine learning model and outputs the trained classifier as source code in a programming language for traditional compiling or interpretation and integration into typical software engineering processes.

When it comes to machine learning, especially supervised classification, the operation of machine learning is currently performed by choosing a model indicated by (sometimes anecdotal) research evidence such as the success of AlexNet™ for image classification or the use of Random Forests for financial predictions and applying it to a new dataset to see how well the resulting predictor would perform on a held-out validation subset of the data set. Alternatively, AutoML tools may be used to brute force model selection by performing trial and error on all possible models. One way or the other, this process relies mostly on luck paired with the guidance of a person with previous experience on similar data such as images, natural languages, financial data sets, etc.

Further, the disclosed apparatus may be configured for automatically preprocessing data for machine learning purposes such as include handling strings, dates, database keys, and floating-point numbers. Further, the disclosed apparatus may be configured for evaluating and quantifying the model ability of a dataset. Further, the disclosed apparatus may be configured for applying data complexity measurements to select the right model for training and avoid hyper-parameter tuning. Further, the disclosed apparatus may be configured for estimating time for architecting and training a machine learning model. Further, the disclosed apparatus may be configured for warning the user if a model overfits. Further, the disclosed apparatus may be configured for compiling all pre-processing steps and other states into a final executable predictor that may be used standalone.

Further, the disclosed system may be configured for evaluating and quantifying the trainability of a dataset in general before training. Further, the disclosed system may be configured for measuring the sufficiency of data for the trainability of a model. Further, the disclosed system may be configured for evaluating and quantifying the trainability with regards to a specific machine learning algorithm without training. Further, the disclosed system may be configured for splitting a dataset into training and evaluation sets automatically. Further, the disclosed system may be configured for automatically pre-processing for machine learning purposes that may include handling strings, dates, database keys, and floating-point numbers.

Further, the disclosed apparatus may include a compiler configured for converting an arbitrary labelled data set into a predictor executable by computer. This is enabled by physics-based, fundamental measurements. While the labelled data set is derived from first principles, the disclosed apparatus may be configured for applying the formulas successfully and productively.

Further, the disclosed apparatus may be configured for automatic tuning-free machine learning on arbitrary data (images, text, speech, etc.) Another unique aspect of the disclosed apparatus is that the output of the compiler is a predictor executable that contains all decisions made during preprocessing, cleaning, architecting of the model, and training to output predictions without requiring further user intervention. Lastly, the disclosed apparatus may be configured for automatic hardware optimization for different hardware at runtime and predictions of time needed for training and risk for overfitting.

Further, the disclosed apparatus may be configured for automatic, tuning-free machine learning on arbitrary data (images, text, speech, etc.). Further, the output of a predictor executable may include all decisions made during pre-processing, cleaning, architecting of the model, and training to output predictions without further user intervention. Further, the disclosed apparatus may be configured for automatic hardware optimization for different hardware at runtime and predictions of time needed for training and risk for overfitting. Further, the disclosed apparatus may include a compiler that converts arbitrary labelled data into a predictor executable by a computer. This is enabled by physics-based, fundamental measurements that we will explain in the next section. While derived from first principles, and thereby being mathematical formulas that are not patentable, our invention is unique in applying these successfully and productively.

Machine Learning, especially supervised classification, is currently performed by choosing a model indicated by research evidence (for example Alexnet for Image classification), ideology (“Random Forests are better”), or brute force (aka AutoML, guess a set of possible models and check if they work) and applying it to a new dataset to see how well the resulting predictor would perform on a held-out validation subset of the dataset. This process relies mostly on luck paired with the guidance of a person with previous experience on similar data (e.g. images, natural language, financial data, etc.). Further, measurements invented for supervised classification derived from the physical world (i.e. SI system) are fully deterministic and allow to replace the state of the art techniques with a systematic model selection, architecture building, and a time-predictable training approach [1]. This allows the inventors to think of machine learning as compiling: A table of labelled data is compiled into an executable predictor (e.g. in Python). The predictors that come out of the disclosed apparatus typically have 2-3 orders of magnitude fewer parameters than the models trained in conventional ways, with about the same accuracy. Further, the disclosed apparatus may be successfully tested on a variety of datasets ranging from small truth tables (e.g., 2-boolean-variable XOR) to large experimental results (e.g. Susy dataset [2] characterizing the Higgs Boson) and from structured (click stream) to computer vision (ImageNet) and audio (sonar event recognition). Out of 176 OpenML binary and multi-class classification tasks, the disclosed apparatus performed better or equal (within 1%) of the state-of-the-art accuracy on 124 tasks and in all cases, the models are at least 2 orders of magnitude smaller, and the training time is at least 2 orders of magnitude faster. The methods disclosed in this filing, make machine learning lean, completely reproducible, and fitting into the traditional software development process. Further, no process can ever guarantee the optimal model but using measurements, the disclosed apparatus may display upper limits of training time and risk of failure before training and accuracy, bias, and generalization after training.

Machine learning and compilation have a joint history. However, to the best of the inventors' knowledge, machine learning is sometimes used in the context of compilation to aid and optimize source-code compilation. This is, compilers accept source code in a programming language as input and output a binary executable. The various optimization problems in that process can then be solved by machine learning. The disclosed apparatus takes data in form of a table as input and outputs source code without the user having to be an expert. In the following, we will illustrate this difference. A Ph.D. Thesis entitled “Using Machine Learning to Automate Compiler Optimization” [3] discusses the use of Machine Learning in source code compilation, replacing optimization processes that are usually done with heuristics. Traditionally, the compiler heuristics make a decision based on source code analysis as to what to optimize, where to optimize, and to what extent to optimize. The exact contents of these heuristics have been carefully tuned by experts, using their experience, as well as analytical tools, to produce a solid performance [3] work proposes an alternative approach—that of using proper statistical analysis to drive these optimization goals instead of human intuition, through the use of machine learning. This work shows how, by using a probabilistic search of the optimization space, one can achieve a significant speedup over the baseline compiler with the highest optimization settings, on a number of different processor architectures. Similar to our disclosed invention, this work discloses a method and process for cleaning data to perform machine learning but it is specific to well-structured input that can be defined by a parseable grammar, aka programming language. It also specifies a method and process to determine the sufficiency of data for classification but it is specific to well-structured input that can be defined by a parseable grammar [3] also outlines a method and process of differentiating a dataset into a training set or a validation set. However, the methods, while automatic, rely on hardcoded decisions that are not measured at runtime. Like many works in the field, the methods outlined in [3] are specific to a particular problem, e.g. source code compiler building, and cannot be used for arbitrary input data. Furthermore, [3] may not disclose a method and process for optimizing accuracy and parameter reduction of the machine learner or the usage of a singular CPU or GPU which reduces the training within minutes rather than hours compared to other machine learning. Last but not least, the thesis describes methods to optimize a source code compiler. Further, the disclosed apparatus represents a full automaton that performs machine learning automatically for any kind of input data. In general, a large amount of work exists in the field similar to [3], as summarized in [4], all of which are limited in scope to the programming language as input. Similarly, there is an abundance of machine learning methods patents for specialized purposes, including U.S. Ser. No. 10/336,298 “Method and System for Identifying Objects in Images”, co-authored by one of the co-authors of this invention. Similarly, there are patents that optimize machine learning with and without specific hardware, for example, U.S. Pat. No. 9,953,270B2 “Scalable, Memory-efficient Machine Learning, and Prediction for Ensembles of Decision Trees for Homogeneous and Heterogeneous Datasets”. This work utilizes a systemic process through a plurality of computer architecture manipulation techniques that take unique advantage of efficiencies therein to minimize clock cycles and memory usage. The disclosed apparatus is an application of machine intelligence that overcomes speed and memory issues in learning ensembles of decision trees in a single-machine environment. Such an application of machine intelligence includes inlining relevant statements by integrating function code into a caller's code, ensuring a contiguous buffering arrangement for the necessary information to be compiled, and defining and enforcing type constraints on programming interfaces that access and manipulate machine learning data sets. Similar to the disclosed apparatus, this published patent discloses a machine learning algorithm that includes a method and process of dataset classification and compiler-like hardware optimization. Unlike our proposed invention, this published patent does not disclose a method and process of differentiating a dataset to a training set or a validation set, a method, and process of measuring the number of parameters, a method and process of selecting the right algorithm for classification, and a method and process of automatically cleaning a dataset to perform machine learning. US20190384800A1 “Machine Learning and Inference System” seems to present a universal system of inference operable to reason about content information and to infer a set of patterns and a set of relationships between patterns of the set of patterns. The machine learning and inference system access content information from a plurality of data sources, such as public and private data sources, the public and private data sources include structured and unstructured data. The machine learning and inference system are operable to reason about the content information and to compile a set of augmented content based at least in part on one or more of the content information, the set of patterns and the set of relationships, and its reasoning about the content information. The machine learning and inference system learns over time and enables nested or hierarchical content augmentation and can be customized for specific industries and content such as financial, medical, health, business, manufacturing, and social media information content. Similar to our invention, this published patent discloses a method and process for automatically cleaning data for the purpose of performing machine learning, except its textual data only. Unlike the disclosed apparatus, this published patent does not disclose the idea of treating machine learning as a compiler, the inventors envision a web-based agent that crawls websites and textual data. It does not disclose a method and process of differentiating training set from validation set based on matching their complexity with respect to the used machine learner, and a method and process of measuring the decision bias of a machine learner. Overall, their system is specialized for textual inference. No measurements are used at all, except for accuracy and user experience.

U.S. Pat. No. 7,778,944B2 “System and Method for Compiling Rules Created by Machine Learning Program” seems to come closest to the apparatus and methods disclosed here. In U.S. Pat. No. 7,778,944B2, a system, a method, and a machine-readable medium are provided. A group of linear rules and associated weights are provided as a result of machine learning. Each one of the groups of linear rules is partitioned into a respective one of a group of types of rules. A respective transducer for each of the linear rules is compiled. A combined finite-state transducer is created from a union of the respective transducers compiled from the linear rules. Similar to our proposed invention, this published patent discloses a machine learning that includes a method of dataset classification, a method, and a process of selecting the right algorithm for classification. Unlike the disclosed apparatus, however, this published patent does not disclose a method to work with non-linear rules or a process of differentiating a dataset to training set or a validation set, a method and process of measuring the decision bias of a machine learner, and a method and process of machine learning that optimizes for accuracy and parameter reduction. More important, it's not an end-to-end system that works on arbitrary sets of data, it's a method that could be embedded into a system. For example, the disclosed apparatus could choose to embed this method as one of the disclosed options.

U.S. Pat. No. 7,778,944B2 does not create a machine-executable predictor and is therefore not an automatic compiler. There is no hardware specialization, as the usage of a GPU or CPU.

An apparatus based on machine learning is presented in Patent US20190102621A1 “Methods and System for the Classification of Materials by Means of Machine Learning”. Their invention is creating a classification unit for the automatic classification of materials. An embodiment of the method includes the provision of a learning computing device; provision of a start classification unit; provision of a reference image set including spectral reference recordings with annotated materials; and training of the classification unit with the reference recording set. Furthermore, the classification method is for the automatic classification of materials in an image recording. An embodiment of the classification method includes the provision of a trained classification unit; provision of a spectral image recording; examination of the image recording for materials via the classification unit; and identification of the determined materials. Furthermore, a classification unit, a learning computing device, a control device, and a medical imaging system are disclosed. While a self-contained device, machine learning is restricted to images and a black-box training process. The device uses a model that has been pre-trained using the expertise of the inventors.

An approach that allows for training is presented by U.S. Pat. No. 9,659,239B2 “Machine Learning Device and Classification Device for Accurately Classifying into Category to which Content Belongs”. An image acquisition unit of a machine learning device acquires n learning images assigned with labels to be used for categorization. A feature vector acquisition unit acquires a feature vector representing a feature from each of the n learning images. A vector conversion unit converts the feature vector for each of the n learning images to a similarity feature vector based on a similarity degree between the learning images. A classification condition learning unit learns a classification condition for categorizing the n learning images, based on the similarity feature vector converted by the vector conversion unit and the label assigned to each of the n learning images. A classification unit categorizes unlabeled testing images in accordance with the classification condition learned by the classification condition learning unit. Like the disclosed apparatus, this published patent discloses an apparatus that includes a method and process for automatically training for classification. However, it is limited to images. Unlike the disclosed apparatus, this published patent does not disclose a method and process of differentiating a dataset to training set or a validation set, a method, and process of measuring the decision bias of a machine learner, a method and process that includes a compiler, and a method and process of machine learning that optimizes for accuracy and parameter reduction. Most importantly, their entire process is specialized to images, and measurements are not used.

Discussion of simulation of machine learners for the pre-training measurements and warnings are presented and described below. The algorithm described in “A Practical Approach to Sizing Neural Networks,” by G. Friedland, A. Meter, and M. Krell, is used to estimate Memory Equivalent Capacity (MEC) requirement given a dataset. Pre-training generalization is estimated by assuming the machine learner achieves 100% accuracy at the estimated MEC. The risk is calculated by dividing the estimated generalization by the information capacity of the machine learner. For binary neurons, which is given by D. MacKay: “Information Theory, Inference, and Learning Algorithms”, Chapter 40, by Cambridge University Press. The method of calculating the information capacity of a multiclass neuron remains a trade secret of the inventors. The capacity progression is generated by estimating the MEC for data partitions of exponentially increasing cardinality. For example, 10%, 20%, 40%, 80%, and 100% of the data.

Moving on to warnings within the present invention: user-readable notes and warnings are output based on a variety of conditions. For example, in cases where the capacity progression does not converge, the user will receive a warning stating that the data is too complex to learn and the model will be expected to overfit. The warnings and notes found within the present invention are generated for a plurality of reasons such as class imbalance, training data sparsity, unique ID columns, and other typical conditions. It is also important to know that the warnings and notes found within the present invention are similar to the warnings and notes that are found within a standard programming language compiler output. The warning and notes associated with the disclosed system may alert the user to situations that are syntactically correct but could semantically cause issues—similar to existing programming language compilers.

Further, the following may be an example output of the measurements for a dataset of DNA samples from colon cancer patients:

Data:
Number of instances: 62
Number of attributes: 2000
Number of classes: 2 Class balance: 62.9% 35.48%
Learnability:
Best guess accuracy: 62.90%
Capacity progression (# of decision points): Dataset too small
Quick Clustering: 34 parameters
Estimated Memory Equivalent Capacity for Neural Networks: 12013
parameters
Risk that model needs to overfit for high accuracies...
using Quick clustering: 100.00%
using Neural Networks: 100.00%
Expected Generalization...
using Quick clustering: 1.82 bits/bit
using a Neural Network: 0.01 bits/bit
Time estimate for a Neural Network:
Estimated time to architect: 0d 0h 0m 1s
Estimated time to prime (subject to change after model architecting): 0d 0h
2m 21s
Time estimate for Quick Clustering:
Estimated time to prime a quick classifier: 5 seconds

Further, the following may be example warnings and notes as generated by the disclosed data compiler:

Recommendations:
Warning: Measurements restricted due to limited number of instances.
Warning: Sparse classes with too few instances will result in overfitting.
Warning: Not enough data to generalize. [red]
Note: Quick Clustering may outperform Neural Networks. Try with -f QC.
Warning: Data has high information density. Expect varying results and
increase --effort.

Further, following is a typical post-training validation measurement:

Classifier Type: Neural Network
System Type: Binary classifier
Best-guess accuracy: 55.50%
Model accuracy: 99.92% (1370/1371 correct)
Improvement over best guess: 44.42% (of possible 44.5%)
Model capacity (MEC): 19 bits
Generalization ratio: 72.10 bits/bit
Model efficiency: 2.33%/parameter
System behavior
True Negatives: 55.51% (761/1371)
True Positives: 44.42% (609/1371)
False Negatives: 0.07% (1/1371)
False Positives: 0.00% (0/1371)
True Pos. Rate/Sensitivity/Recall: 1.00
True Neg. Rate/Specificity: 1.00
Precision: 1.00
F-1 Measure: 1.00
False Negative Rate/Miss Rate: 0.00
Critical Success Index: 1.00
Overfitting: No
Classifier Type: Neural Network
System Type: 3-way classifier
Best-guess accuracy: 34.46%
Model accuracy: 60.92% (92/151 correct)
Improvement over best guess: 26.46% (of possible 65.54%)
Model capacity (MEC): 39 bits
Generalization ratio: 2.35 bits/bit
Confusion Matrix:
[23.18% 3.97% 7.28%]
[10.60% 15.89% 6.62%]
[4.64% 5.96% 21.85%]
Overfitting: No
-ignorelabels IGNORELABELS
Comma-separated list of rows of classes to ignore.
-rank [ATTRIBUTERANK], --attributerank [ATTRIBUTERANK]
Rank columns by significance, only process contributing
attributes. If optional parameter n is given, force the use top n attributes.
-v, --verbosity Verbosity (0: default, 1: measurements, 2+: debug)
-biasmeter Measure bias (only NN).
-measureonly Only output measurements, no compilation.
-Wall Display all warnings
-pedantic Display all notes and warnings.
-nofun Stop compilation if there are warnings.
-f FORCEMODEL, --forcemodel FORCEMODEL
Force model type: QC, NN, RF, GMM
-O OPTIMIZE, --optimize OPTIMIZE
Optimize for: accuracy, TP, F1
-e EFFORT, --effort EFFORT
1=<effort<100. More careful model creation. Default: 1
--yes No interaction. Default to yes for all questions.
-stopat STOPAT Stop when percentage goal has been reached. Default:
100
-modelonly Output model only in ONNX file format. No predictor.
-riskoverfit Prioritize validation accuracy over generalization.
Default: Prioritize generalization over accuracy.
-nopriming Do not prime the model
-novalidation Do not measure validation scores for created predictor.

The accuracy measurements are obtained by running the original CSV file through the final predictor and comparing the results of the predictor with the original labels. The MEC is obtained through actual counting of parameters and analysis of the topology of the generated model. Generalization is then computed based on actual accuracy and actual MEC. Overfitting is determined by comparing the final generalization ratio with the information capacity of the given machine learner. If the generalization ratio is below or equal to the information capacity, the model will overfit.

Further, the predictor may be written to a file in a programming language of choice, such as Python or BASIC, ready to be interpreted or further processed to a binary executable via standard code compilation techniques. The source code may include all information necessary to reproduce the prediction results and to reproduce the predictor from the data. The process from data file to predictor may be fully automatic without user intervention or understanding of the measurements.

Further, the following may be a demonstration of the screen output of a fully automatic run:

fractor@StormCloud client % ./btc_mac ../qa/data/bank.csv
Brainome Dimensions(tm) 0.96 Copyright (c) 2019, 2020 by Brainome,
Inc. All Rights Reserved.
Connected to Brainome cloud.
Input: ../qa/data/bank.csv
Sampling...done.
Cleaning...done.
Splitting into training and validation...done
Pre-training measurements...done.
Architecting model...done.
Model capacity (MEC): 19 bits
Architecture efficiency: 1.0 bits/parameter
Estimating time to prime model...done.
Estimated time to prime model: 0d 0h 2m 24s
Priming model...done.
Compiling predictor...done.
Validating predictor...done.
Output: a.py
READY.

It is important to note that every automated decision can be overridden by the user for utility purposes. Further, the following is an illustration of sets of options available to the user to override steps of the automatic process:

usage: btc [-h] [-o [OUTPUT]] [-headerless] [-cm CLASSMAPPING]
[-nc NCLASSES]
[-l LANGUAGE] [-target TARGET] [-nsamples NSAMPLES]
[-ignorecolumns IGNORECOLUMNS] [-ignorelabels IGNORELABELS]
[-rank [ATTRIBUTERANK]] [-v] [-biasmeter] [-measureonly] [-Wall]
[-pedantic] [-nofun] [-f FORCEMODEL] [-O OPTIMIZE] [-e EFFORT]
[--yes] [-stopat STOP AT] [-modelonly] [-riskoverfit] [-nopriming]
[-novalidation]
input [input ...]
Brainome Daimensions(tm) Table Compiler
positional arguments:
input Table as CSV files and/or URLs.
Alternatively, one of: {VERSION, TERMINATE, WIPE,
CHPASSWD}
VERSION: return version and exit.
TERMINATE: terminate all cloud processes.
WIPE: deletes all files in the cloud.
CHPASSWD: Change password
optional arguments:
-h, --help show this help message and exit
-o [OUTPUT], --output [OUTPUT]
Output predictor
-headerless Headerless inputfile
-cm CLASSMAPPING, --classmapping CLASSMAPPING
Manually map class labels to contiguous numeric range.
Python dictionary format.
-nc NCLASSES, --nclasses NCLASSES
Specify number of classes. Stop if not matched by
input.
-l LANGUAGE, --language LANGUAGE
Predictor language: py, exe
-target TARGET Specify target attribute (name or number)
-nsamples NSAMPLES Work on n random samples (0 full dataset,
default: 1000000). Balancing is not performed.
-ignorecolumns IGNORECOLUMNS
Comma-separated list of attributes to ignore (names or numbers).

The next topic of discussion found and used within the present invention is time estimation. The time to train a model is maximally exponential to its MEC. A memory equivalent capacity of n bits implies that the trained model will end up in one of 2n states. In theory, the maximum time it takes to train a model is the time it takes to set and check all 2n parameter states. Even for small n (e.g., n=256), iterating through all states of the machine learner to find the best parameter state is prohibitive. Resulting in a global minimum error stating that the minimum cannot be found. Machine learning algorithms, therefore, try to find the quickest ways to reach local minima, in the case of Neural Networks by utilizing statistical methods.

In the said case above, the disclosed system may fix the number of iterations to a constant as suggested by “Optimization for Machine Learning,” Chapter 13: The Tradeoffs of Large Scale Learning,” by S. Sra, Nowozin, and S. Wrights. If the desired result isn't achieved, we rerun for another constant time with new initial conditions. By the usage of a constant number of iterations, prediction for runtime is much easier. The time estimator runs 4 iterations of the training process and extrapolates to the full number of iterations. The user is given the option to choose how often that constant-length training process should be repeated with new random initial conditions. Furthermore, the time for architecting a model is estimated in the same way. Several iterations of the building process are run and interpolated to the number of iterations it would take to reach MEC. All of the time estimates that are conducted by the present invention are overestimated, guaranteeing that the actual times are lower.

Furthermore, a discussion of the automatic splitting of the data into training and validation is presented and described. Machine learning uses the splitting of the input data into training and validation to prevent memorization. The parameters of a machine learner are adjusted using the training set, but success is evaluated using the test set. The current existing theory requires training and validation set are independent and identically distributed random variables. The problem that arises, in this case, is that it is difficult to enforce and measure. On the other hand, the present invention has two important rules. Rule one, no sample of the training set can be identified with a sample in the validation set. Rule two, the estimated MEC of the training set should be identical to the estimated MEC of the test set. Therefore, the disclosed system iterates from 60:40 to 90:10 test split into small steps and choose the split that conforms best. Two criteria are used for this: Criteria one, ensures that the validation set cannot be predicted by memorization of the training set alone. Criteria two, ensure that the validation set has the same representative complexity as the training set. Performing well on a validation set with a lower complexity would not be a good indicator of success. Choosing a validation set with higher complexity than the training set, will in most cases, lead to very low training success and low validation accuracy. Comparable complexity is therefore a key element that is measurable with the tools found within the present invention.

Lastly, a method of compiling all preprocessing steps and other states into a final executable predictor that can be used standalone is disclosed and described. The final predictor is created by generating programming language source code to repeat all steps needed during the compilation phase, but the trained model is inserted into the code. The model is inserted by being translated into explicit formulas interpretable by a programming language compiler. The code is inserted before the classification, such that all preprocessing steps, including cleaning, produce a result identical to what was presented in training to create the model.

Consider the following thought experiment associated with two sequences:

Sequence 1: “0, 20, 40, 60, 80, 100, 120”

Sequence 2: “1, −4, 1.1, 52, 2, 9”

In the first sequence, the possibly most economical strategy to reproduce the numbers is to remember the initial number “0” and generalize the rule “+20”. In the second sequence, it's not immediately clear what the underlying rule is so the quickest strategy to not lose any information is to memorize the entire sequence. These two sequences illustrate how one can intuitively interpret memorization as a worst-case generalization: Memorization only allows to compare to known input and requires verbatim storage while generalization is more effective than verbatim storage and at the same time allows to generate correct answers on similar, but unseen input (e.g., “200” would be the next number given the unseen input “180”), which is usually called “generalization”. We can therefore define memorization as a worst-case generalization. While the math behind generalization is generally unknown, the math behind memorization is well known and has been established in 1949 by Claude Shannon [5]. The unit of memorization is the binary digit (bit) and it is widely established that memory measurement does not differ based on the type of data one is memorizing (images, speech, text, etc. . . . ). The goal of machine learning is to create a model that generalizes. A model that only memorizes is generally said to “overfit the data”. We also know that memorization can be more or less efficient. For example, one can store a 7-digit phone number on a hard disk with 1 TB space. Similarly, machine learning models and the rules they contain can be even larger than needed for memorization of the input data. This may or may not be a problem. For example, the rule “+20” could be represented as “+1+1+1+1+1+1+1+1+1+1+1+1+1+1+1+1+1+1+1+1” and, while longer than the original input sequence, the rule still generalizes. So while a machine learning model that implements a rule that has a longer description length than the input sequence may still generalize, practically speaking we may not be able to distinguish easily between generalization and overfitting in such a case. However, when a rule implemented by a model has a shorter description length compared to its original training input and it achieves very high accuracy when tested and the model generalizes. This is, to make lives easier, the principle of Occam's Razor may be followed and define a goal in machine learning to be a maximal reduction of the number of parameters in the model while at the same time maximizing the accuracy. The connection between the number of parameters (seen as a description length of the model) has been explained fundamentally by [6]. Further, a machine learner may be put as an encoder into Shannon's communication model. This is, a machine learner transcodes the training data into parameters of a predefined function. Similarly, a file that is compressed using the ZIP algorithm (U.S. Pat. No. 4,464,650 “Apparatus and method for compressing data signals and restoring the compressed data signals”) is transcoded into parameters for the unzip function. ZIP implements an algorithm that tries to minimize these parameters and make them storable in much less space than the original file while at the same time making the file recoverable using unzip, thus achieving description length reduction aka compression.

Given a machine learning model, the first question therefore is: How many parameters are minimally needed to encode and then decode the function represented by the training data? This is, what is the minimum number of parameters to reproduce the mapping represented by the training data with 100% accuracy [6]. Which, as explained above, is equivalent to asking how many parameters would overfit the training data. To make this process measurable, it may be known how many bits of the training function each parameter can maximally memorize. This is dependent on the machine learner and also on the task that is being performed. For simplicity, binary (two-label) classification may only be focused. For this task, the question was solved for decision trees by Shannon [5] and for Neural Networks by Friedland et al. [7].

Friedland et al. define what they call the Memory Equivalent Capacity [1]. A machine learner's capacity is memory-equivalent to N bits when the machine learner is able to represent all 2 N binary labeling functions of N inputs. This means that a machine learner is overfitting the training data when it's Memory Equivalent Capacity is greater or equal to the number of instances in the training data for a binary classification task. For example, when 10 training samples are given for a binary classification task and a perfect binary tree with depth 10 is used to classify the problem, the model overfits. For neural networks, [7] presents rules to derive the Memory Equivalent Capacity for neural networks by treating neurons like elements in an electrical circuit.

Using the explanation above, generalization capability for binary classification may be measured as the following ratio: G=# correctly classified instances/Memory Equivalent Capacity, where G is measured after the model is created and on all unique inputs the model can represent correctly. The larger G, the higher the generalization capability. As a consequence of the above derivation, if G<=1, the model is overfitting. The more samples of the training data may be labeled correctly by each parameter of the model, the higher the probability that a parameter can correctly label an unseen input. Going back to the example from the beginning, the rule “+20” is able to predict Sequence 1 with 100% accuracy but this model only takes 3 characters to memorize. This is, as explained above, the goal is to minimize parameters, this is minimizing Memory Equivalent Capacity while at the same time maximizing accuracy.

The generalization of Memory Equivalent Capacity to non-binary classification tasks and other machine learning algorithms remains the trade secret. Further explanation of the concept of Memory Equivalent Capacity and generalization is available as an online lecture [such as YouTube™].

In the following section, the capacity and generalization measurements used to fully automate classification for arbitrary input data may be outlined.

Apparatus for Building Executable Classifiers may include 6 main steps that incorporate several measurements and methods that will be disclosed in this document. The apparatus can be used without expertise in machine learning or artificial intelligence. Since it behaves analog to a traditional source code compiler, it mostly requires the knowledge of how to run a compiler, which is frequently taught in middle school. The disclosed system may be configured for receiving 2-dimensional tabular data, such as a comma-separated-value file as defined in RFC 4180. These files are generally generated out of databases or spreadsheets such as Excel. The only additional requirement is that the user dedicates one column as the target column. This is the column that contains the labels. The first step (step i) then consists of checking the CSV files for errors and converting them into an intermediate format that only contains numbers.

After cleaning, steps ii and iii are the pre-training data analysis. Apart from basic statistics, results based on a simulation of different machine learners are presented, including the Memory Equivalent Capacity required for the dataset using the different machine learners, capacity progression, as well as overfitting risk, and the estimated times that it would take to architect and train models using the different machine learning algorithms.

The following is an example output of measurements for a dataset of DNA samples from colon cancer patients:

Brainome Daimensions(tm) 0.97 Copyright (c) 2019, 2020 by Brainome,
Inc. All Rights Reserved.
Data:
Number of instances: 62
Number of attributes: 2000
Number of classes: 2
Class balance: 62.9% 35.48%
Learnability:
Best guess accuracy: 62.90%
Capacity progression (# of decision points): Dataset too small
Quick Clustering: 34 parameters
Estimated Memory Equivalent Capacity for Neural Networks: 12013
parameters
Risk that model needs to overfit for high accuracies...
using Quick clustering: 100.00%
using Neural Networks: 100.00%
Expected Generalization...
using Quick clustering: 1.82 bits/bit
using a Neural Network: 0.01 bits/bit
Time estimate for a Neural Network:
Estimated time to architect: 0d 0h 0m 1s
Estimated time to prime (subject to change after model architecting): 0d 0h
2m 21s
Time estimate for Quick Clustering:
Estimated time to prime a quick classifier: 5 seconds

Step iv and v consist of architecting and training a model. These steps are completely dependent on the outcome of the measurements phase in step ii. Unless overridden by the user, the compiler chose the machine learning algorithm that has the best possible generalization. The training/validation split is also chosen using Memory Equivalent Capacity. This is, to make sure the test set is representative of the training set, yet separate, we iterate through different training/test splits with ratios between 60:40 and 90:10 and choose the one where Memory Equivalent Capacity per sample is most comparable. We then build the machine learner step by step, subsequently adding parameters only if accuracy is increased while generalization stays within the bounds. The concrete algorithm to subsequently architect a neural network and a decision tree stays undisclosed. For neural networks, training consists of standard, GPU-based stochastic gradient descent [8].

Step vi consists of linkage of a final predictor and validation of it using post-training measurements. The following is typical post-training measurements:

Classifier Type: Neural Network
System Type: Binary classifier
Best-guess accuracy: 55.50%
Model accuracy: 99.92% (1370/1371 correct)
Improvement over best guess: 44.42% (of possible 44.5%)
Model capacity (MEC): 19 bits
Generalization ratio: 72.10 bits/bit
Model efficiency: 2.33%/parameter
System behavior
True Negatives: 55.51% (761/1371)
True Positives: 44.42% (609/1371)
False Negatives: 0.07% (1/1371)
False Positives: 0.00% (0/1371)
True Pos. Rate/Sensitivity/Recall: 1.00
True Neg. Rate/Specificity: 1.00
Precision: 1.00
F-1 Measure: 1.00
False Negative Rate/Miss Rate: 0.00
Critical Success Index: 1.00
Overfitting: No
The following is post-training measurements for a multiclass-classifier
(here: 3-class):
Classifier Type: Neural Network
System Type: 3-way classifier
Best-guess accuracy: 34.46%
Model accuracy: 60.92% (92/151 correct)
Improvement over best guess: 26.46% (of possible 65.54%)
Model capacity (MEC): 39 bits
Generalization ratio: 2.35 bits/bit
Confusion Matrix:
[23.18% 3.97% 7.28%]
[10.60% 15.89% 6.62%]
[4.64% 5.96% 21.85%]
Overfitting: No.

The accuracy measurements are obtained by running the original CSV file through the final predictor and comparing the results of the predictor with the original labels. The Memory Equivalent Capacity is obtained through actual counting of parameters analysis of the topology of the generated model. A generalization is then computed based on actual accuracy and actual Memory Equivalent Capacity. Overfitting is determined by comparing the final generalization ratio with the information capacity of the given machine learner. If the generalization ratio is below or equal to the information capacity, the model overfits.

The final predictor is written to a file in a programming language of choice ready to be interpreted (e.g. Python, Basic) or further processed to a binary executable via standard code compilation techniques. The source code contains all information necessary to reproduce the prediction results and also to reproduce the predictor from that data. Appendix A shows an example of the predictor source code. The process from data file to predictor can be run fully automatically without user intervention or understanding of the measurements.

Following demonstrates the screen output of a fully automatic run:

fractor@StormCloud client % ./btc mac ../qa/data/bank.csv
Brainome Daimensions(tm) 0.96 Copyright (c) 2019, 2020 by Brainome,
Inc. All Rights Reserved.
Connected to Brainome cloud.
Input: ../qa/data/bank.csv
Sampling...done.
Cleaning...done.
Splitting into training and validation...done
Pre-training measurements...done.
Architecting model...done.
Model capacity (MEC): 19 bits
Architecture efficiency: 1.0 bits/parameter
Estimating time to prime model...done.
Estimated time to prime model: 0d 0h 2m 24s
Priming model...done.
Compiling predictor...done.
Validating predictor...done.
Output: a.py/
READY.

However, to leave the human the ultimate control. virtually every automatic decision can be overridden by the user.

Following shows the set of options presented to the user on the command line to override steps of the automatic process:

usage: btc [-h] [-o [OUTPUT]] [-headerless] [-cm CLASSMAPPING]
[-nc NCLASSES]
[-l LANGUAGE] [-target TARGET] [-nsamples NSAMPLES]
[-ignorecolumns IGNORECOLUMNS] [-ignorelabels IGNORELABELS]
[-rank [ATTRIBUTERANK]] [-v] [-biasmeter] [-measureonly] [-Wall]
[-pedantic] [-nofun] [-f FORCEMODEL] [-O OPTIMIZE] [-e EFFORT]
[--yes] [-stopat STOPAT] [-modelonly] [-riskoverfit] [-nopriming]
[-novalidation]
input [input ...]
Brainome Daimensions(tm) Table Compiler
positional arguments:
input Table as CSV files and/or URLs.
Alternatively, one of: {VERSION, TERMINATE, WIPE,
CHPASSWD}
VERSION: return version and exit.
TERMINATE: terminate all cloud processes.
WIPE: deletes all files in the cloud.
CHPASSWD: Change password
optional arguments:
-h, --help show this help message and exit
-o [OUTPUT], --output [OUTPUT]
Output predictor
-headerless Headerless inputfile
-cm CLASSMAPPING, --classmapping CLASSMAPPING
Manually map class labels to contiguous numeric range.
Python dictionary format.
-nc NCLASSES, --nclasses NCLASSES
Specify number of classes. Stop if not matched by
input.
-l LANGUAGE, --language LANGUAGE
Predictor language: py, exe
-target TARGET Specify target attribute (name or number)
-nsamples NSAMPLES Work on n random samples (0 full dataset,
default: 1000000). Balancing is not performed.
-ignorecolumns IGNORECOLUMNS
Comma-separated list of attributes to ignore (names or
numbers).
-ignorelabels IGNORELABELS
Comma-separated list of rows of classes to ignore.
-rank [ATTRIBUTERANK], --attributerank [ATTRIBUTERANK]
Rank columns by significance, only process contributing
attributes. If optional parameter n is given, force the use top n attributes.
-v, --verbosity Verbosity (0: default, 1: measurements, 2+: debug)
-biasmeter Measure bias (only NN).
-measureonly Only output measurements, no compilation.
-Wall Display all warnings
-pedantic Display all notes and warnings.
-nofun Stop compilation if there are warnings.
-f FORCEMODEL, --forcemodel FORCEMODEL
Force model type: QC, NN, RF, GMM
-O OPTIMIZE, --optimize OPTIMIZE
Optimize for: accuracy, TP, F1
-e EFFORT, --effort EFFORT
1=<effort<100. More careful model creation. Default: 1
--yes No interaction. Default to yes for all questions.
-stopat STOPAT Stop when percentage goal has been reached. Default:
100
-modelonly Output model only in ONNX file format. No predictor.
-riskoverfit Prioritize validation accuracy over generalization.
Default: Prioritize generalization over accuracy.
-nopriming Do not prime the model
-novalidation Do not measure validation scores for created predictor.
Automatic Cleaning Method

In the following, the algorithm for automatic cleaning of 2-dimensional tabular data may be outlined. The assumption is that the input is in the form of a CSV file, conforming to RFC 4180. Other tabular data may be processed in the same way. A CSV file can contain a header or not. Based on RFC 4180 the ambiguities resulting from that choice have to be resolved by the user. This is why the disclosed apparatus contains a parameter that allows declaration to the system if the CSV file is headerless. Otherwise, a headered CSV file is assumed. The cleaning assumes that the labels are located in the right-most column. This, as well, can be overridden by the user. The cleaning algorithm is then performed as follows:

1) If there is a header, save it and start at the second row, if not, apply all processing row by row from the first row.

2) Read each cell of a row and try to convert it to a floating-point number. If unsuccessful, treat as a string. If successful try to convert it to an integer. If that succeeds keep the integer. If it doesn't but the floating-point conversion succeeded, keep the floating-point number. If the cell is treated as a string, convert the cell to the CRC32 representation of the string. If a cell is empty, it is considered the empty string and is assigned the CRC32 value 0.

3) Error check: If the number of columns is different from the header, stop, and present an error.

4) When all rows are processed:
a) Check for the number of classes defined by the labeling in the target column. If the number of classes is equal to the number of rows, return an error message as this problem represents a regression problem and not a classification problem
b) If the number of classes is smaller than 1, return an error message that at least two classes are needed to draw a distinction.

The cleaned file now only contains floating-point numbers and integers and is ready to be used as input for the further algorithms which can treat the input as a mathematical matrix.

Simulation of Machine Learners for the Pre-Training Measurements and Warnings

Further, the algorithm described in [7] may be followed to estimate the Memory Equivalent Capacity requirement given a dataset. Pre-training generalization is estimated by assuming the machine learner achieves 100% accuracy at the estimated Memory Equivalent Capacity. Risk is calculated by dividing the estimated generalization by the Information capacity of the machine learner. For binary neurons, this is given by [6]. The method of calculating the information capacity of a multiclass neuron remains a trade secret of the inventors. The capacity progression is generated by estimating the Memory Equivalent Capacity for data partitions of exponentially increasing cardinality, for example, 10%, 20%, 40%, 80%, and 100% of the data.

User-readable notes and warnings are output based on various conditions. For example, if the capacity progression does not converge, the user is warned that the data is hard to learn and the model will most likely overfit. Warnings are also generated for class imbalance, training data sparsity, unique ID columns, and other typical conditions. These warnings and notes are similar to the warnings and notes that a programming language compiler outputs. Warnings and notes in a programming language compiler alert the user to situations that are syntactically correct but could semantically cause issues. Same in the disclosed invention.

Following is an example set of warnings and notes for a particularly bad data file.

Recommendations:

Warning: Measurements restricted due to limited number of instances.

Warning: Sparse classes with too few instances will result in overfitting.

Warning: Not enough data to generalize. [red]

Note: Quick Clustering may outperform Neural Networks. Try with -f QC.

Warning: Data has high information density. Expect varying results and increase-effort.

The time to train a model is maximally exponential to its Memory Equivalent Capacity. A memory equivalent capacity of n bits implies that the trained model will end up in one of 2 n states. This is, in theory, the maximum time it takes to train a model is a time it takes to train all 2 n parameter states. Unfortunately, even for small n (e.g., n=256), iterating through all states of the machine learner to find the best parameter state is prohibitive. This is, a global minimum error minimum cannot be found. Machine learning algorithms, therefore, try to find the quickest ways to reach local minima, in the case of Neural Networks using statistical methods.

Knowing that this is the case we can fix the number of iterations to a constant and rather re-run the statistical methods [8] with new initial conditions. Using a constant number of iterations, it is very easy to predict runtime: run 4 iterations of the training process and interpolate. The user then has a choice, how often that constant-length training process should be repeated with new random initial conditions. The parameter is called effort.

The time for architecting a model is estimated in the same way: Several iterations of the building process are run and interpolated to the number of iterations it would take to reach Memory Equivalent Capacity.

All-time estimates are overestimated. This is, actual times are usually lower.

Memorization is typically prevented in machine learning by splitting the data into training and validation sets. The parameters of a machine learner are adjusted using the training set but success is evaluated using the test set. The current theory requires that the training and validation set are i.i.d., which is independent but identically distributed. The problem with this requirement is that it is hard to enforce and measure. Instead, the disclosed invention follows the following rules:

a) No sample of the training set can be identified with a sample in the validation set

b) The estimated Memory Equivalent Capacity of the training set should be identical to the estimated Memory Equivalent Capacity of the test set.

Further, iterate from 60:40 to 90:10 test splits in 5% steps and the split that conforms best may be chosen. Criterion a) ensures that the validation set cannot be predicted by memorization of the training set alone and criterion b) ensures that the validation set has the same representative complexity as the training set. Performing well on a validation set with lower complexity would not be a good indicator of success. Choosing a validation set with higher complexity than the training set, will in most cases lead to very low training success (low accuracies). Comparable complexity is therefore a key element that is measurable with the tools disclosed here.

Further, the disclosed system may be configured for compiling all pre-processing steps and other states into a final executable predictor that can be used standalone.

The final predictor is created by generating programming language source code to repeat all steps needed during the compilation phase, except that the trained model is inserted into the code. To insert the model, it is translated into explicit formulas interpretable by a programming language compiler. Code is inserted before the classification, such that all preprocessing steps, including cleaning, produce a result identical to what was presented in training to create the model.

Further, Appendix A shows an example of a final compiled predictor.

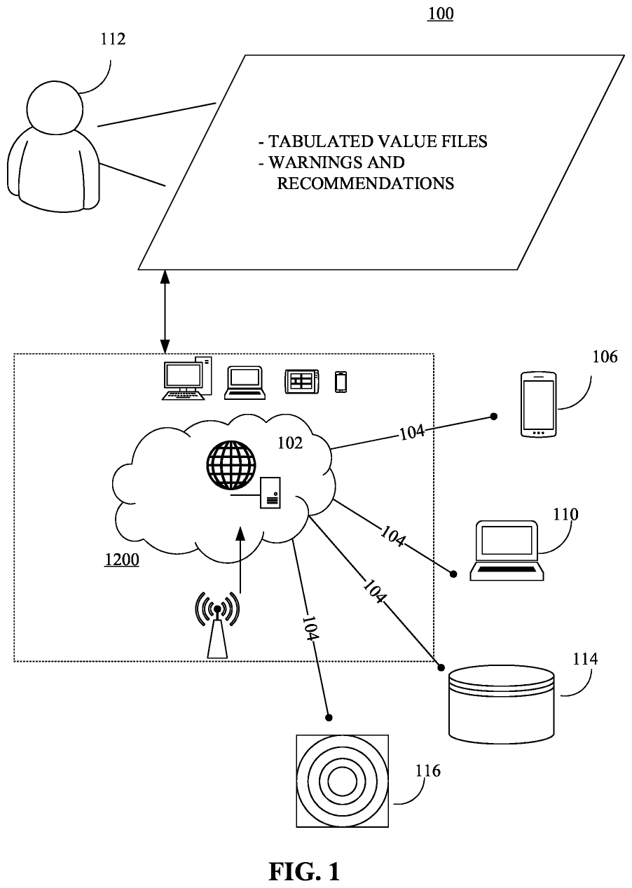

Referring now to figures, FIG. 1 is an illustration of an online platform 100 consistent with various embodiments of the present disclosure. By way of non-limiting example, the online platform 100 to facilitate classification of labelled data may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1200.

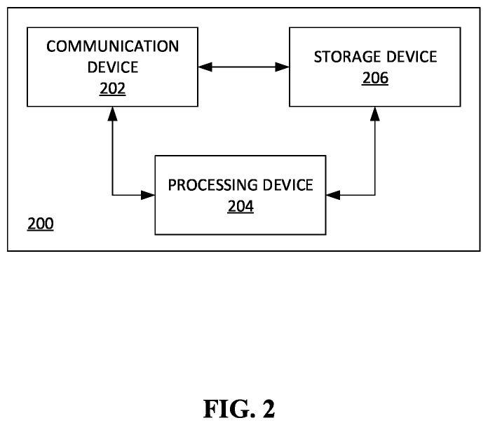

FIG. 2 is a block diagram of a system 200 for facilitating classification of labelled data, in accordance with some embodiments. Accordingly, the system 200 may include a communication device 202 configured for receiving at least one tabulated value file from at least one device.

Further, the system 200 may include a processing device 204 communicatively coupled with the communication device 202. Further, the processing device 204 may be configured for analyzing the at least one tabulated value file. Further, the processing device 204 may be configured for determining a complexity of the labelled data of the at least one tabulated value file with respect to a plurality of machine learning methods used for generating a machine learning model for classifying the labelled data based on the analyzing. Further, the processing device 204 may be configured for identifying a machine learning method of the plurality of machine learning methods based on the determining. Further, the processing device 204 may be configured for configuring a topology of a machine learning model associated with the machine learning method based on the identifying. Further, the processing device 204 may be configured for training at least one parameter of the machine learning model based on the configuring. Further, the processing device 204 may be configured for generating an executable classifier based on the training. Further, the executable classifier may be configured for classifying the labelled data of the at least one tabulated file based on executing of the executable classifier.

Further, the system 200 may include a storage device 206 communicatively coupled with the processing device 204. Further, the storage device 206 may be configured for storing the executable classifier.

Further, in some embodiments, the processing device 204 may be configured for determining an error in the labelled data of the at least one tabulated value file based on the analyzing. Further, the processing device 204 may be configured for converting the at least one tabulated value file from a common format to an intermediate format based on the determining of the error. Further, the determining of the complexity of the labelled data may be based on the converting.

Further, in some embodiments, the processing device 204 may be configured for generating a plurality of simulations for the labelled data of the at least one tabulated value file using the plurality of machine learning methods. Further, the processing device 204 may be configured for determining at least one measurement associated with the labelled data of the at least tabulated value file based on the plurality of simulations. Further, the identifying of the machine learning method may be based on the determining of the at least one measurement.

Further, in some embodiments, the at least one measurement may include a memory equivalent capacity. Further, the processing device 204 may be further configured for splitting the labelled data between a training labelled data of the labelled data and a validating labelled data of the labelled data in a ratio based on the memory equivalent capacity. Further, the training of the at least one parameter of the machine learning model may be based on the training labelled data. Further, the ratio ranges from 60:40 to 90:10.

Further, in some embodiments, the processing device 204 may be configured for validating the machine learning model using the validating labelled data based on the splitting and the training. Further, the generating of the executable classifier may be based on the validating.

Further, in some embodiments, the processing device 204 may be configured for preprocessing the labelled data of the at least one tabulated value file based on the analyzing of the at least one tabulated value file. Further, the labelled data may include at least one of strings, dates, database keys, and floating point numbers. Further, the preprocessing may include handling the at least one of the strings, the dates, the database keys, and the floating point numbers. Further, the determining of the complexity may be based on the preprocessing.

Further, in some embodiments, the processing device 204 may be configured for determining an ability to model the labelled data of the at least one tabulated value file based on the analyzing of the at least one tabulated value file. Further, the determining of the complexity of the labelled data of the at least one tabulated value file may be based on the ability to model the labelled data of the at least one tabulated value file.

Further, in some embodiments, the processing device 204 may be configured for analyzing the machine learning model associated with the labelled data of the at least one tabulated value file based on the training. Further, the processing device 204 may be configured for determining an overfitting in the machine learning model based on the analyzing of the machine learning model. Further, the processing device 204 may be configured for generating a warning based on the determining of the overfitting. Further, the communication device 202 may be configured for transmitting the warning to the at least one device.

Further, in some embodiments, the labelled data of the at least one tabulated value file may include two-dimensional tabular data. Further, the two-dimensional tabular data may include a plurality of columns. Further, a target column of the plurality of columns may include a plurality of labels.

Further, in some embodiments, the executable classifier may include a source code in at least one programming language. Further, the source code may be configured to be compiled and interpreted for the executing of the executable classifier.

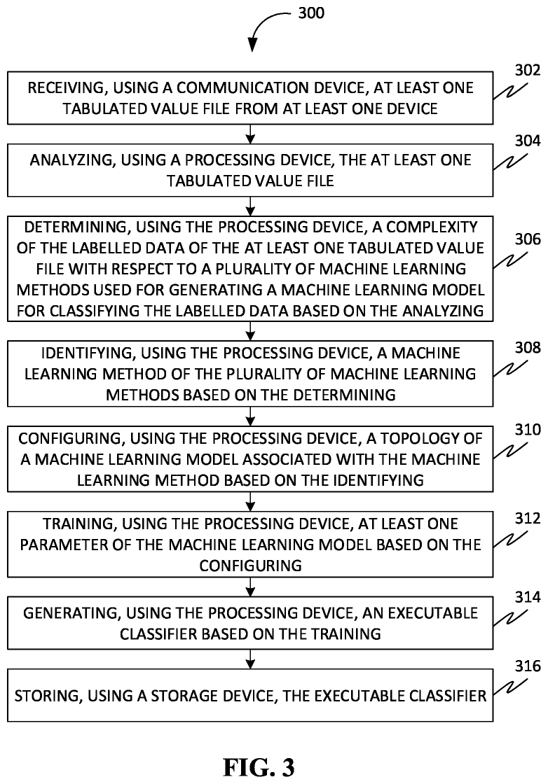

FIG. 3 is a flowchart of a method 300 for facilitating classification of labelled data, in accordance with some embodiments. Accordingly, at 302, the method 300 may include receiving, using a communication device, at least one tabulated value file from at least one device.

Further, at 304, the method 300 may include analyzing, using a processing device, the at least one tabulated value file.

Further, at 306, the method 300 may include determining, using the processing device, a complexity of the labelled data of the at least one tabulated value file with respect to a plurality of machine learning methods used for generating a machine learning model for classifying the labelled data based on the analyzing.

Further, at 308, the method 300 may include identifying, using the processing device, a machine learning method of the plurality of machine learning methods based on the determining.

Further, at 310, the method 300 may include configuring, using the processing device, a topology of a machine learning model associated with the machine learning method based on the identifying.

Further, at 312, the method 300 may include training, using the processing device, at least one parameter of the machine learning model based on the configuring.

Further, at 314, the method 300 may include generating, using the processing device, an executable classifier based on the training. Further, the executable classifier may be configured for classifying the labelled data of the at least one tabulated file based on executing of the executable classifier.

Further, at 316, the method 300 may include storing, using a storage device, the executable classifier.

Further, the method 300 may include preprocessing, using the processing device, the labelled data of the at least one tabulated value file based on the analyzing of the at least one tabulated value file. Further, the labelled data may include at least one of strings, dates, database keys, and floating point numbers. Further, the preprocessing may include handling the at least one of the strings, the dates, the database keys, and the floating point numbers. Further, the determining of the complexity may be based on the preprocessing.

Further, the method 300 may include determining, using the processing device, an ability to model the labelled data of the at least one tabulated value file based on the analyzing of the at least one tabulated value file. Further, the determining of the complexity of the labelled data of the at least one tabulated value file may be based on the ability to model the labelled data of the at least one tabulated value file.

Further, in some embodiments, the labelled data of the at least one tabulated value file may include two-dimensional tabular data. Further, the two-dimensional tabular data may include a plurality of columns. Further, a target column of the plurality of columns may include a plurality of labels.

Further, in some embodiments, the executable classifier may include a source code in at least one programming language. Further, the source code may be configured to be compiled and interpreted for the executing of the executable classifier.

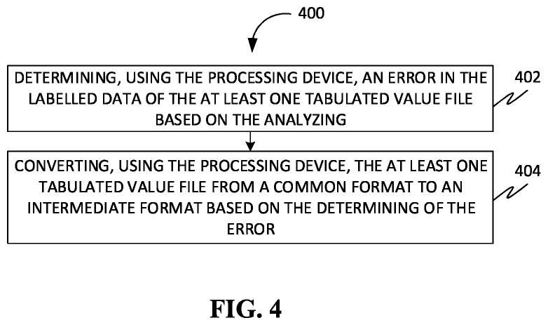

FIG. 4 is a flowchart of a method 400 for converting the at least one tabulated value file from a common format to an intermediate format for facilitating the classification of the labelled data, in accordance with some embodiments. Accordingly, at 402, the method 400 may include determining, using the processing device, an error in the labelled data of the at least one tabulated value file based on the analyzing.

Further, at 404, the method 400 may include converting, using the processing device, the at least one tabulated value file from a common format to an intermediate format based on the determining of the error. Further, the determining of the complexity of the labelled data may be based on the converting.

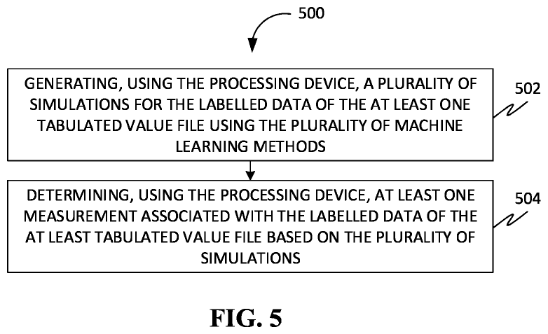

FIG. 5 is a flowchart of a method 500 for determining at least one measurement for facilitating the classification of the labelled data, in accordance with some embodiments. Accordingly, at 502, the method 500 may include generating, using the processing device, a plurality of simulations for the labelled data of the at least one tabulated value file using the plurality of machine learning methods.

Further, at 504, the method 500 may include determining, using the processing device, at least one measurement associated with the labelled data of the at least tabulated value file based on the plurality of simulations. Further, the identifying of the machine learning method may be based on the determining of the at least one measurement.

Further, in some embodiments, the at least one measurement may include a memory equivalent capacity. Further, the method 500 may include splitting, using the processing device, the labelled data between a training labelled data of the labelled data and a validating labelled data of the labelled data in a ratio based on the memory equivalent capacity. Further, the training of the at least one parameter of the machine learning model may be based on the training labelled data. Further, the ratio ranges from 60:40 to 90:10.

Further, in some embodiments, the method 500 may include validating, using the processing device, the machine learning model using the validating labelled data based on the splitting and the training. Further, the generating of the executable classifier may be based on the validating.

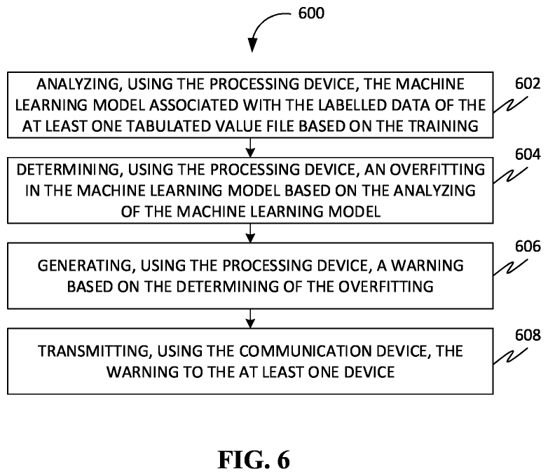

FIG. 6 is a flowchart of a method 600 for generating a warning for facilitating the classification of the labelled data, in accordance with some embodiments. Accordingly, at 602, the method 600 may include analyzing, using the processing device, the machine learning model associated with the labelled data of the at least one tabulated value file based on the training.

Further, at 604, the method 600 may include determining, using the processing device, an overfitting in the machine learning model based on the analyzing of the machine learning model;

Further, at 606, the method 600 may include generating, using the processing device, a warning based on the determining of the overfitting; and

Further, at 608, the method 600 may include transmitting, using the communication device, the warning to the at least one device.

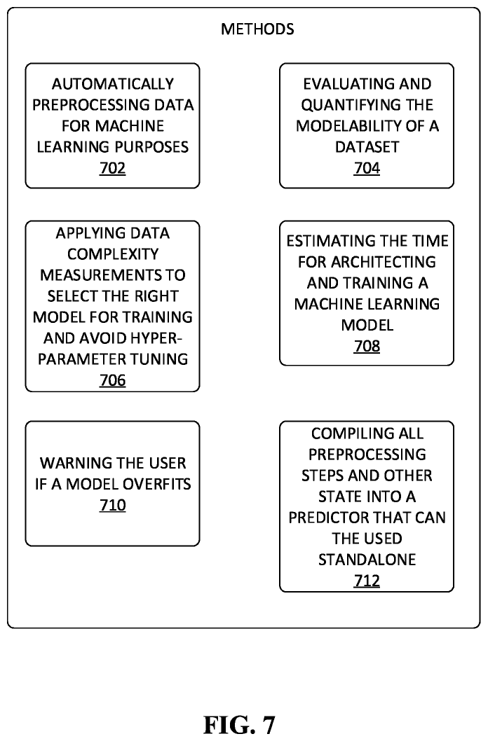

FIG. 7 illustrates a plurality of methods 702-712 associated with the disclosed apparatus, in accordance with some embodiments. Accordingly, the plurality of methods 702-712 may include a plurality of different measurement and data processing methods. Further, the plurality of methods 702-712 may include a method 702 for automatically preprocessing data for machine learning purposes (including handling strings, dates, database keys, and floating point numbers). Further, the plurality of methods 702-712 may include a method 704 for evaluating and quantifying the ability to model a dataset. Further, the plurality of methods 702-712 may include a method 706 of applying data complexity measurements to select a right model for training and avoid hyper-parameter tuning. Further, the plurality of methods 702-712 may include a method 708 of estimating the time for architecting and training a machine learning model. Further, the plurality of methods 702-712 may include a method 710 of warning the user if a model overfits. Further, the plurality of methods 702-712 may include a method 712 of compiling all preprocessing steps and other state into a final executable predictor.

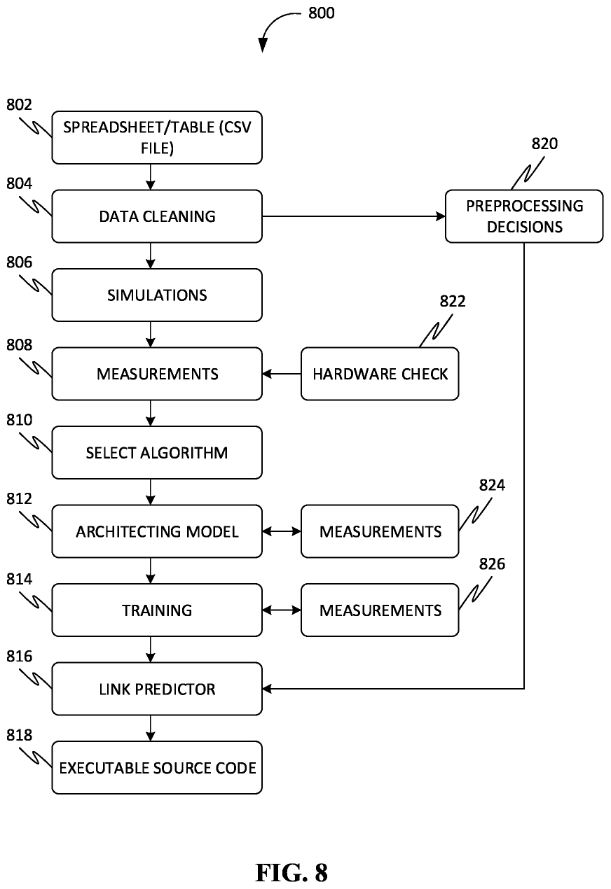

FIG. 8 is a flow chart of a method 800 for facilitating building a classifier, in accordance with some embodiments. Accordingly, to start off, the disclosed system may be used without expertise in machine learning or artificial intelligence. Further, the disclosed apparatus behaves analog to a traditional source code compiler that mainly requires knowledge to run the compiler. The disclosed apparatus may be configured receiving 2-dimensional tabular data, such as a comma-separated-value file as defined by RFC 4180. RFC 4180 is a common format and a multipurpose Internet mail extension type for comma-separated values (CSV) files. The RFC4180 format is generally generated by exporting data out of databases or spreadsheets such as Excel. Further, a user may be required to dedicate one column of the dataset as a target column. The target column may include labels. Further, the target column, by default, may be the rightmost column. Further, at 802, the method 800 may include a step of checking the CSV files for errors and converting the CSV files into an intermediate format that only may include numbers.

Further, at 804, the method 800 may include a step of data cleaning.

Further, after 804, at 806, the method 800 may include a step of simulations. Further, at 808, the method 800 may include measurements with the assistance of a hardware check 822. Further, simulations and measurements with the assistance of hardware check may be pre-training data analysis. Aside from the fundamental statistics, results based on a simulation of different machine learning may be presented, which includes the Memory Equivalent Capacity (MEC) required for the dataset using the different machine learners, capacity progression, as well as overfitting risk and the estimated times that it would take to architect and train models using the different machine learning algorithms.

Further, at 810, the method 800 may include selecting algorithm.

Further, at 812, the method 800 may include architecting of a model based on measurements 824. Further, at 814, the method 800 may include training of the model based on measurements 826. Further, architecting the model and training of the model may be dependent on outcome of the measurements phase. Except for cases when it is overridden by the user, the compiler may choose a machine learning algorithm that has the best possible generalization. Further, the training (or validation) split may be chosen using the MEC. In order to make sure the validation set is representative of the training set, the measurement may iterate through different training/validation splits with ratios between 60:40 and 90:10. The iteration where the MEC is the most similar per sample between the two sets may be chosen. This leads to the next steps: incrementally building the machine learner by subsequently adding parameters only if validation accuracy is increased while generalization stays within the boundary, this is, the parameter count stays below MEC. Once the machine learner is architected, it is trained using standard methods. For neural networks, training consists of standard GPU-based stochastic gradient descent which is an iterative method for optimizing an objective function with suitable smoothness properties. It is important to note that the concrete algorithm to subsequently architect a neural network or a decision tree stays undisclosed.

Further, at 816, the method 800 may include ‘link predictor’ that may include linkage of a predictor by integrating the model with the preprocessing and cleaning decisions and a final validation of it using post-training measurements. Further, at 818, the method 800 may include executable source code. Further, after 804, at 820, the method 800 may include pre-processing decisions. Further, after 820, the method 800 may lead to the link predictor.

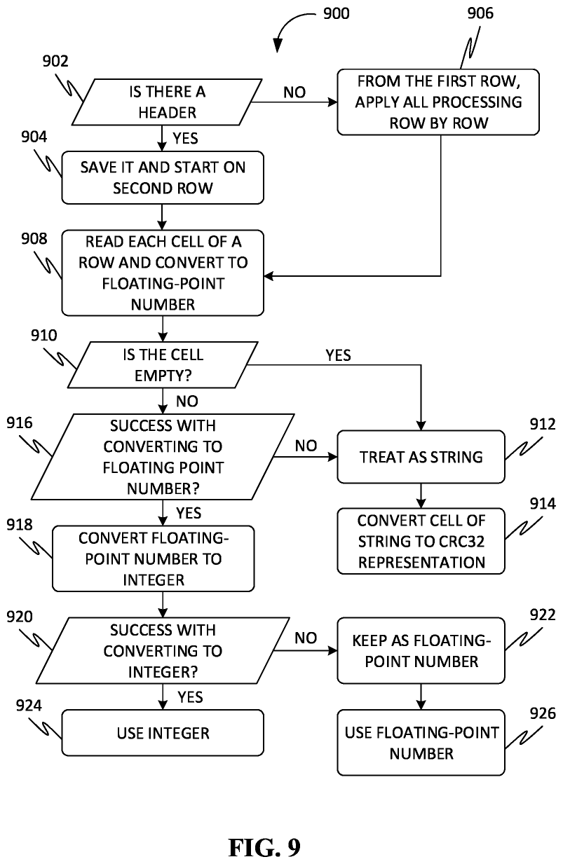

FIG. 9 is a flow diagram of an automatic cleaning method 900 for facilitating the building of the classifier, in accordance with some embodiments. Accordingly, the method 900 may be associated with a cleaning algorithm for automatic cleaning of 2-dimensional tabular data. Further, the assumption is that the input is in the form of a CSV file, conforming to RFC 4180. Further, other existing tabular data may be processed the same way. Further, at 902, the method 900 may include checking a CSV file to include a header or not. Based on the RFC 4180, the ambiguities resulting from that choice have to be resolved by the user. Therefore, the disclosed apparatus may include a parameter that allows declaration to the system if the CSV file does not have a header. Otherwise, the CSV file is assumed to include the header. Further, the cleaning algorithm defaults to the labels being located in the right-most column that may be overridden by the user. Further, the cleaning algorithm may be performed in a series of steps. Further, at 904, if the CSV includes the header. The method 900 may include saving the CSV and the process begins at the second row. Further, if the CSV does not include the header, at 906, the method 900 may include applying all processing row by row from the first row. Further, at 908, the method 900 may include reading each cell of each row and converting to a floating-point number. Further, at 910, the method 900 may include checking if the cell is empty. Further, after 912, the method 900 may include treating the rows that are unable to be converted to a floating-point number as a string. Further, after 910, at 916, the method 900 may include confirming success with converting to the floating pint number. After 916, at 918, the method 900 may include taking the floating-point numbers and converting the floating-point numbers to an integer. Further, at 920, the method 900 may include confirming success in conversion to the integer. Further, after 920, at 922, the method 900 may include keeping the floating-point number upon failure of conversion to the integer. Further, after 920, at 924, the method 900 may include. Further, at 914, the method 900 may include converting the cells that remained a string due to failure to convert to the floating-point number to the CRC32 representation of the string. In cases where a cell is empty, the cell may be considered an empty string and is assigned the CRC32 value of the empty string. Further, after 920, at 924, the method 900 may include using the integer. Further, after 922, at 926, the method 900 may include using the floating-point number.

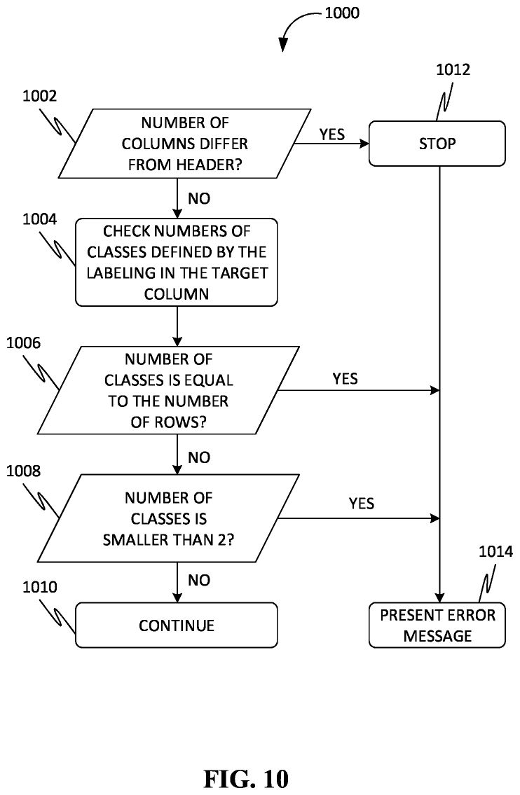

FIG. 10 is a flow diagram of a method 1000 for error check for facilitating the building of the classifier, in accordance with some embodiments. Accordingly, at 1002, the method 1000 may include checking if the number of columns is different from the header. Further, at 1012, the method 1000 may stop to present an error message at 1014. If no errors are presented and after all rows are processed, two major checks are needed. Further, after 1002, at 1004, the method 1000 may include a first check of the two major checks to check for the number of classes defined by the labeling in the target column. Further, at 1006, the method 1000 may include checking if the number of classes is equal to the number of rows. Further, upon confirming the number of classes equal to the number of rows, the method 1000 may proceed to represent the error message 1014 as this problem represents a regression problem and not a classification problem. Further, after 1006, at 1008, the method 1000 may include checking if the number of classes is smaller than 2. Further, upon confirming the number of classes smaller than 2, the method 1000 may return the error message at 1014, that at least two classes are needed to draw a distinction. Further, if the number of classes is not smaller than 2, at 1010, the method 1000 may include a step of continue. For internal technical reasons, the class labels are remapped to contiguous integers, if the classes are not contiguous already. After the cleaning algorithm, the cleaned file now only contains floating-point numbers and integers and is ready to be used as input for the further algorithms which are able to treat the input as a mathematical matrix.

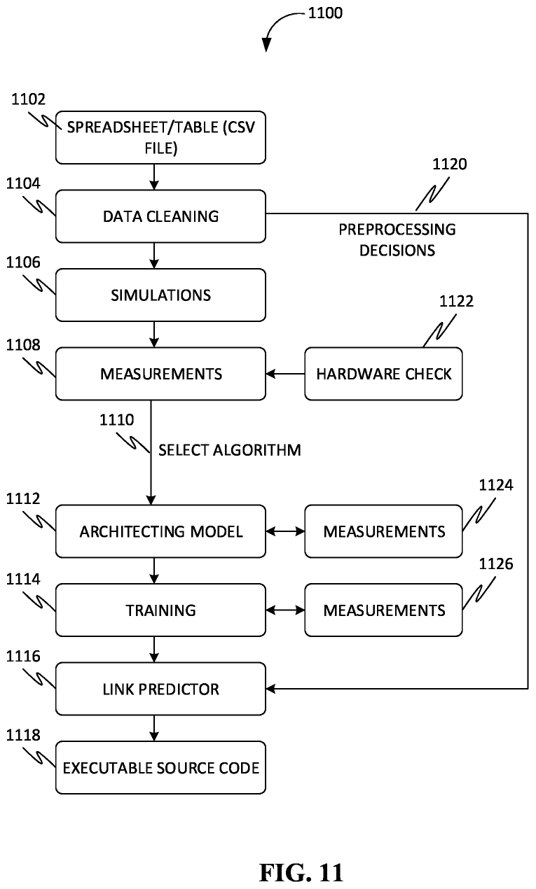

FIG. 11 is a flow diagram of a method 1100 for building executable classifiers, in accordance with some embodiments. Accordingly, at 1102, the method 1100 may include a step of receiving 2-dimensional tabular data, such as a Comma-Separated-Value (CSV) file as defined in RFC 4180. Further, the CSV file may be generally generated out of databases or spreadsheets such as Excel. The only additional requirement is that the user dedicates one column as the target column. This is the column that contains the labels. The method 1100 may include checking the CSV files for errors and converting it into an intermediate format that only contains numbers. Further, at 1104, the method 1100 may include data cleaning.

Further, at 1106, the method 1100 may include a step of simulations associated with the pre-training data analysis. Further, at 1108, the method 1100 may include measurements using a hardware check 1122. Further, at 1110, the method 1100 may include selecting an algorithm, Apart from basic statistics, results based on the simulation of different machine learners may be presented, including the Memory Equivalent Capacity required for the dataset using the different machine learners, capacity progression, as well as overfitting risk and the estimated times that it would take to architect and train models using the different machine learning algorithms.

Further, at 1112, the method 1100 may include a step of architecting a model using measurements 1124 (such as the measurements 1108). Further, at 1114, the method 1100 may include a step of training the model using measurements 1126 (such as the measurements 1108). Further, the step of architecting the model and training the model may be completely dependent on the outcome of the measurements phase at 1108. Unless overridden by the user, the compiler chose the machine learning algorithm that has the best possible generalization. The training/validation split is also chosen using Memory Equivalent Capacity. This is, in order to make sure the test set is representative of the training set, yet separate, iteration through different training/test splits with ratios between 60:40 and 90:10 may be performed and choose the one where Memory Equivalent Capacity per sample is most comparable. Further, the machine learner may be built step by step, subsequently adding parameters only if accuracy is increased while generalization stays within the bounds. The concrete algorithm to subsequently architect a neural network and a decision tree stays undisclosed. For neural networks, training consists of standard, GPU-based stochastic gradient descent [8].

Further, at 1116, the method 1100 may include a step of linkage of a final predictor and validation of the final predictor using post-training measurements. Further, at 1118, the method 1100 may include executable source code. Further, after 1104, at 1120, the method 1100 may include preprocessing decisions. Further, after 1104, at 1120, the method 1100 may progress to 1116.

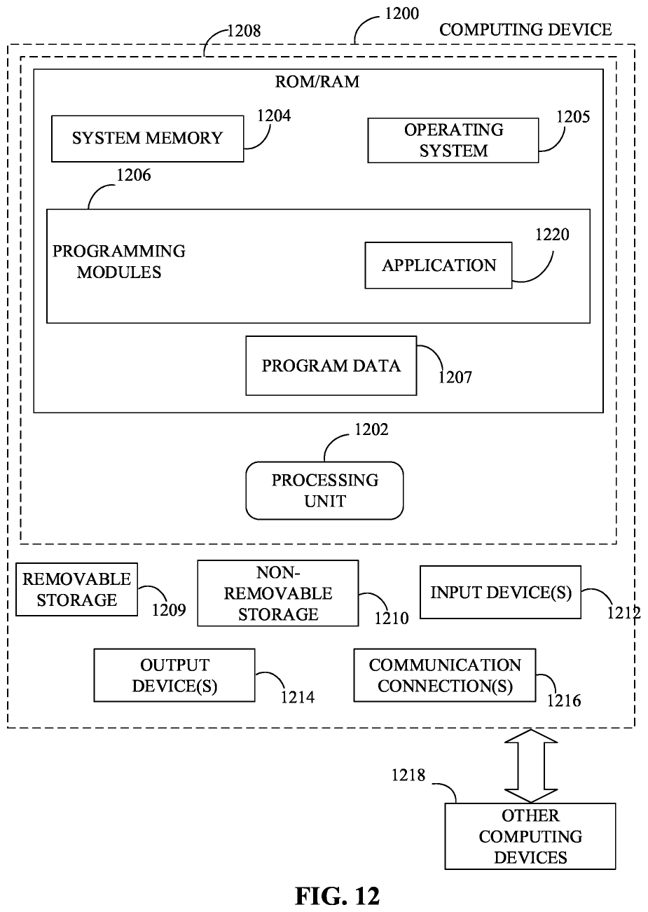

With reference to FIG. 12, a system consistent with an embodiment of the disclosure may include a computing device or cloud service, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random-access memory (RAM)), non-volatile (e.g. read-only memory (ROM)), flash memory, or any combination. System memory 1204 may include operating system 1205, one or more programming modules 1206, and may include a program data 1207. Operating system 1205, for example, may be suitable for controlling computing device 1200's operation. In one embodiment, programming modules 1206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and non-volatile, removable and non-removable media implemented in any method or technology for storage of information, such as computer-readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, a location sensor, a camera, a biometric sensor, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g., application 1220) may perform processes including, for example, one or more stages of methods, algorithms, systems, applications, servers, databases as described above. The aforementioned process is an example, and processing unit 1202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

### REFERENCES

[1 ] G. Friedland, Reproducibility and Experimental Design for Machine Learning on Audio and Multimedia Data, MM '19: Proceedings of the 27th ACM International Conference on Multimedia, pp. 2709-2710, October 2019.
[2] P. Baldi, P. Sadowski, and D. Whiteson. “Searching for Exotic Particles in High-energy Physics with Deep Learning.” Nature Communications 5.
[3] J. D. Thomson: “Using Machine Learning to Automate Compiler Optimisation”, PhD Thesis, University of Edinburgh 2008.
[4] Z. Whang and M. O'Boyle: “Machine Learning in Compiler Optimization”, https://arxiv.org/pdf/1805.03441.pdf
[5] C. E. Shannon: “A Mathematical Theory of Communication”, The Bell System Technical Journal, Vol. 27, pp. 379-423, 623-656, July, October, 1948.
[6] D. J. C. MacKay, “Information Theory, Inference, and Learning Algorithms”, Chapter 40, Cambridge University Press, 2003.
[7] G. Friedland, A. Meter, and M. Krell, “A Practical Approach to Sizing Neural Networks”, 2018. https://arxiv.org/abs/1810.02328
[8] L. Bottou, O. Bousquet: “The Tradeoffs of Large Scale Learning” in S. Sra, S. Nowozin, and S. Wright (eds.). Optimization for Machine Learning. Cambridge: MIT Press. pp. 351-368, 2012.
[9] Lisinski, S. (2019). Transparent pane having a heatable coating (U.S. Pat. No. 10,336,298). U.S. Patent and Trademark Office. https://cutt.ly/BjWdIq8
[10] Eads, D. R. (2018). Scalable, memory-efficient machine learning and prediction for ensembles of decision trees for homogeneous and heterogeneous datasets (U.S. Pat. No. 9,953,270). U.S. Patent and Trademark Office. https://cutt.ly/fjWdLzL
[11] Elassaad, S. (2019). Machine Learning and Inference System (U.S. Patent No. 20190384800). U.S. Patent and Trademark Office. https://cutt.ly/MjWfRku
[12] FLOHR, T. (2019). Methods and System for the Classification of Materials by Means of Machine Learning (U.S. Patent No. 20190102621). U.S. Patent and Trademark Office. https://cutt.ly/KjWfCDb
[13] Matsunaga, K. (2017). Machine learning device and classification device for accurately classifying into category to which content belongs (U.S. Pat. No. 9,659,239). U.S. Patent and Trademark Office. https://cutt.ly/sjWf32q
[14] Bangalore, S. (2010). System and method for compiling rules created by machine learning program (U.S. Pat. No. 7,778,944). U.S. Patent and Trademark Office. https://cutt.ly/UjWjqJq

What is claimed is:

1. A method for facilitating classification of labelled data, the method comprising:
receiving, using a communication device, at least one tabulated value file from at least one device;
analyzing, using a processing device, the at least one tabulated value file;
determining, using the processing device, a complexity of the labelled data of the at least one tabulated value file with respect to a plurality of machine learning methods used for generating a machine learning model for classifying the labelled data based on the analyzing;
identifying, using the processing device, a machine learning method of the plurality of machine learning methods based on the determining;
configuring, using the processing device, a topology of a machine learning model associated with the machine learning method based on the identifying;
training, using the processing device, at least one parameter of the machine learning model based on the configuring;
generating, using the processing device, an executable classifier based on the training, wherein the executable classifier is configured for classifying the labelled data of the at least one tabulated file based on executing of the executable classifier; and
storing, using a storage device, the executable classifier.

2. The method of claim 1 further comprising:
determining, using the processing device, an error in the labelled data of the at least one tabulated value file based on the analyzing; and
converting, using the processing device, the at least one tabulated value file from a common format to an intermediate format based on the determining of the error, wherein the determining of the complexity of the labelled data is further based on the converting.

3. The method of claim 1 further comprising:
generating, using the processing device, a plurality of simulations for the labelled data of the at least one tabulated value file using the plurality of machine learning methods; and
determining, using the processing device, at least one measurement associated with the labelled data of the at least tabulated value file based on the plurality of simulations, wherein the identifying of the machine learning method is further based on the determining of the at least one measurement.

4. The method of claim 3, wherein the at least one measurement comprises a memory equivalent capacity, wherein the method further comprises splitting, using the processing device, the labelled data between a training labelled data of the labelled data and a validating labelled data of the labelled data in a ratio based on the memory equivalent capacity, wherein the training of the at least one parameter of the machine learning model is further based on the training labelled data.

5. The method of claim 4 further comprising validating, using the processing device, the machine learning model using the validating labelled data based on the splitting and the training, wherein the generating of the executable classifier is further based on the validating.

6. The method of claim 1 further comprising preprocessing, using the processing device, the labelled data of the at least one tabulated value file based on the analyzing of the at least one tabulated value file, wherein the labelled data comprises at least one of strings, dates, database keys, and floating point numbers, wherein the preprocessing comprises handling the at least one of the strings, the dates, the database keys, and the floating point numbers, wherein the determining of the complexity is further based on the preprocessing.

7. The method of claim 1 further comprising determining, using the processing device, an ability to model the labelled data of the at least one tabulated value file based on the analyzing of the at least one tabulated value file, wherein the determining of the complexity of the labelled data of the at least one tabulated value file is further based on the ability to model the labelled data of the at least one tabulated value file.

8. The method of claim 1 further comprising:
analyzing, using the processing device, the machine learning model associated with the labelled data of the at least one tabulated value file based on the training;
determining, using the processing device, an overfitting in the machine learning model based on the analyzing of the machine learning model;
generating, using the processing device, a warning based on the determining of the overfitting; and
transmitting, using the communication device, the warning to the at least one device.

9. The method of claim 1, wherein the labelled data of the at least one tabulated value file comprises two-dimensional tabular data, wherein the two-dimensional tabular data comprises a plurality of columns, wherein a target column of the plurality of columns comprises a plurality of labels.

10. The method of claim 1, wherein the executable classifier comprises a source code in at least one programming language, wherein the source code is configured to be compiled and interpreted for the executing of the executable classifier.

11. A system for facilitating classification of labelled data, the system comprising:
a communication device configured for receiving at least one tabulated value file from at least one device;
a processing device communicatively coupled with the communication device, wherein the processing device is configured for:
analyzing the at least one tabulated value file;
determining a complexity of the labelled data of the at least one tabulated value file with respect to a plurality of machine learning methods used for generating a machine learning model for classifying the labelled data based on the analyzing;
identifying a machine learning method of the plurality of machine learning methods based on the determining;
configuring a topology of a machine learning model associated with the machine learning method based on the identifying;
training at least one parameter of the machine learning model based on the configuring; and
generating an executable classifier based on the training, wherein the executable classifier is configured for classifying the labelled data of the at least one tabulated file based on executing of the executable classifier; and
a storage device communicatively coupled with the processing device,
wherein the storage device is configured for storing the executable classifier.

12. The system of claim 11, wherein the processing device is further configured for:
determining an error in the labelled data of the at least one tabulated value file based on the analyzing; and
converting the at least one tabulated value file from a common format to an intermediate format based on the determining of the error, wherein the determining of the complexity of the labelled data is further based on the converting.

13. The system of claim 11, wherein the processing device is further configured for:
generating a plurality of simulations for the labelled data of the at least one tabulated value file using the plurality of machine learning methods; and
determining at least one measurement associated with the labelled data of the at least tabulated value file based on the plurality of simulations, wherein the identifying of the machine learning method is further based on the determining of the at least one measurement.

14. The system of claim 13, wherein the at least one measurement comprises a memory equivalent capacity, wherein the processing device is further configured for splitting the labelled data between a training labelled data of the labelled data and a validating labelled data of the labelled data in a ratio based on the memory equivalent capacity, wherein the training of the at least one parameter of the machine learning model is further based on the training labelled data.

15. The system of claim 14, wherein the processing device is further configured for validating the machine learning model using the validating labelled data based on the splitting and the training, wherein the generating of the executable classifier is further based on the validating.

16. The system of claim 11, wherein the processing device is further configured for preprocessing the labelled data of the at least one tabulated value file based on the analyzing of the at least one tabulated value file, wherein the labelled data comprises at least one of strings, dates, database keys, and floating point numbers, wherein the preprocessing comprises handling the at least one of the strings, the dates, the database keys, and the floating point numbers, wherein the determining of the complexity is further based on the preprocessing.

17. The system of claim 11, wherein the processing device is further configured for determining an ability to model the labelled data of the at least one tabulated value file based on the analyzing of the at least one tabulated value file, wherein the determining of the complexity of the labelled data of the at least one tabulated value file is further based on the ability to model the labelled data of the at least one tabulated value file.

18. The system of claim 11, wherein the processing device is further configured for:
analyzing the machine learning model associated with the labelled data of the at least one tabulated value file based on the training;
determining an overfitting in the machine learning model based on the analyzing of the machine learning model; and
generating a warning based on the determining of the overfitting, wherein the communication device is configured for transmitting the warning to the at least one device.

19. The system of claim 11, wherein the labelled data of the at least one tabulated value file comprises two-dimensional tabular data, wherein the two-dimensional tabular data comprises a plurality of columns, wherein a target column of the plurality of columns comprises a plurality of labels.

20. The system of claim 11, wherein the executable classifier comprises a source code in at least one programming language, wherein the source code is configured to be compiled and interpreted for the executing of the executable classifier.
